(19) United States
(12) Patent Application Publication
(10) Pub. No.: US 2007/0024070 A1
(43) Pub. Date: Feb. 1, 2007

(54) Rechargeable pet waste cleaner

(76) Inventor: Mathias Aihiokhai, Bronx, NY (US)

Correspondence Address: MATHIAS AIHIOKHAI, 2242 LIGHT STREET, BRONX, NY, 10466, US

(21) Appl. No.: 11/494,167

(22) Filed: Jul. 27, 2006

Related U.S. Application Data
(60) Provisional application No. 60/704,247, filed on Aug. 1, 2005.

(51) Int. Cl. A01K 29/00

(52) U.S. Cl. 294/1.4

(57) ABSTRACT

A rechargeable pet waste cleaner that uses two rotating brushes to pick up waste, for easy suctioning by suction force created by a motor and fan. The said motor is capable of changing direction of rotation in other to flush the unit by forcing soap and water in a flush chamber over the rotating brushes. It is a cordless light weight device, slim and strong and serves as a walking cane with a wheel.

### CROSS REFERENCE TO RELATED APPLICATION

This application claims the benefit of U.S provisional patent application, application No. 60/704,247 filed on Aug. 1, 2005.

### BACKGROUND OF THE INVENTION

1. Field of the Invention

the present invention relates generally to a cordless animal waste removal device, more specifically, the invention is a pet waste removal device which enables the user to sweep and suck up pet litter into a disposable bag without the strain of bending over in the process.

2. Description of Related Art

the related art of interest describes various pet litter devices, but none discloses the present invention. A few of the device available operate on mechanical system with the use of grasping jaws and handles. A lot of them are bulky and made of heavy materials which make it inconvenient for the user to easily walk the dog and carry along these devices for long walks.

some of the related device available today make use of covers for the grasping jaws, usually with plastic bags which are loosely wrapped around the jaws. This makes this device clumsy and difficult to use These devices lack a specialized cleaning unit for effectively cleaning the unit after use.

some devices have been proposed for solving these problems.

U.S. Pat. No. 5,503,442, issued to Ke-Chiang Lee in April 1996, describes a pick-up device for picking up animal feces. The device is intended for the use with bags and requires the use of a bag dispenser attached to the device's handle.

U.S. Pat. No. 6,135,520, issued to Micheal T. miller on Oct. 24, 2000, describes a pick-up device for picking up animal waste. The device does not incorporate the use of a disposable bag; rather, feces are collected in a compartment that has a cover lid.

U.S. Pat. No. 6,763,782B1 issued to Tapio Kordelin on Jul. 20, 2004, describes a lavatory for pets. This is a none mobile device, stationary and can not be used out door while walking a pet.

None of the above patents describes a sanitary waste removal device that can be operated with a single hand, with a flush system for cleaning the unit, and can serve as a walking cane that sucks in feces into a disposable bag.

none of the above inventions and patents, taken either singly or in combination, is seen to describe the instant invention as claimed.

### SUMMARY OF THE INVENTION

the invention is a pet waste cleaning device that has the shape of a walking cane with a broad base. It comprises of a grooved handle featuring finger indentations covered in a non skid rubber or similar material to ensure steady grip. A simple power switch is positioned at the top end of the handle for activating the unit. A second switch just under the main power switch serves the purpose of activating the flush system by changing the direction of rotation of the main vacuum motor. Housed in the mid section of the rechargeable pet waste cleaner is the said vacuum motor which provides powerful vacuum suction for the vacuum head. The said vacuum head is positioned at the distal end of the unit. Horizontally positioned across the bottom of the vacuum head are a set of two rotating spindle about 5 inches apart. these spindles have numerous bristles made of rubber or similar material. They both function as two spindle shaped brushes rotating in opposite direction and complimenting each other in picking up pet waste. The front spindle has a few sharp steal blades which help to reduce the size of the waste into smaller bits that can easily be suctioned up into a disposable bag in a hollow chamber located above the vacuum head. A hinged or snap fitted access panel positioned on the chamber allows for empting the disposable bag. The spindles are powered by a separate motor with the aid of a belt and two gears. An opening positioned at the base of the unit would be used to introduce powder/liquid soap and water for flushing the unit.

accordingly, it is a principal object of the invention to provide a rechargeable pet waste cleaning device.

it is another object of the invention to provide a rechargeable pet waste cleaner having rotating brushes with several steal blades which cut waste into smaller bits for easy suctioning.

it is further object of the invention to provide a rechargeable pet waste cleaning device having a second rotating brush to complement the first brush in picking up waste from the ground as they both rotate towards the direction of the suction force.

it is still another object of the invention to provide a rechargeable pet waste cleaning device that can be operated with one hand and measure approximately 2 feet″ 2 inches in total length.

it is an object of the invention to provide a rechargeable pet waste cleaner that is made from light weight materials and yet strong and serve also as a walking cane with a wheel.

these and other objects of the invention will become readily apparent upon further review of the following specification and drawings.

### BRIEF DESCRIPTION OF THE DRAWINGS

FIG. 1. shows a vertical side view of the device in one plain.

FIG. 2. Shows in a perspective view an embodiment of the device according to the invention.

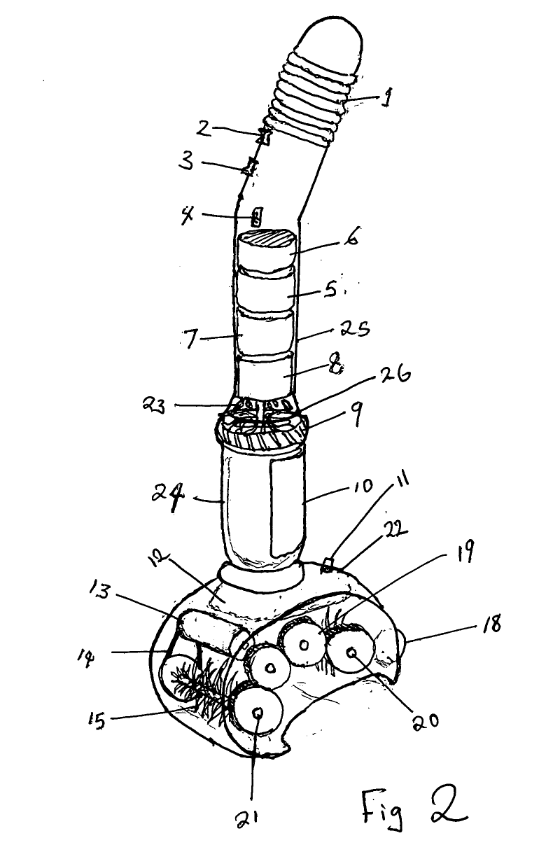

FIG. 3. Exploded perspective view of parts of the device.

FIG. 4. Exploded perspective view of a single component of the device.

### DETAILED DESCRIPTION OF PREFERED EMBODIMENT

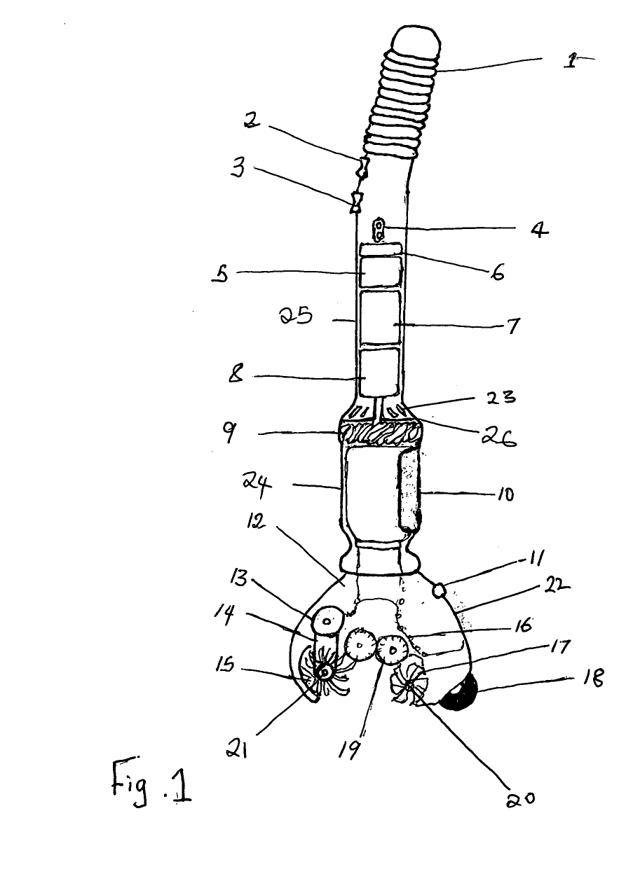

The present invention as shown in FIG. 1 enables a pet owner to clean up the solid pet waste deposited on any hard surface without bending over and with minimum effort to suck up with the aid of two rotating brushes 21 and 22, waste is sucked into hollow compartment 24 lined with disposable bag. Suction is provided by powerful motor 8 that rotate fan 9 powered by rechargeable battery pack 7. The said Battery Park 7 is recharged by battery charger unit 6 while the voltage from the battery is stepped up to a higher voltage by the A/C D/C converter 5 to power the two directional rotating motor 7.

the base of this device has a small water/soap chamber 12 housed above the brushes 21 and 22. The chamber is perforated at the bottom with tiny perforations 16. The chamber has an opening 11 from which soap and water is introduced. When the flush switch 3 is turned on, the motor 8 changes direction of rotation with the aid of two pairs of electric motor brushes, separate pair for each direction of rotation. These special brushes incorporated into the motor, makes the motor a reversible electric motor.

when the direction of rotation of the motor changes, the motor becomes a pump, forcing the water and soap in the soap/water chamber 12 out through the tiny perforations 16 so as to wash the brushes.

the main switch and the flush switch are independently capable of turning on the spindle motor 13.

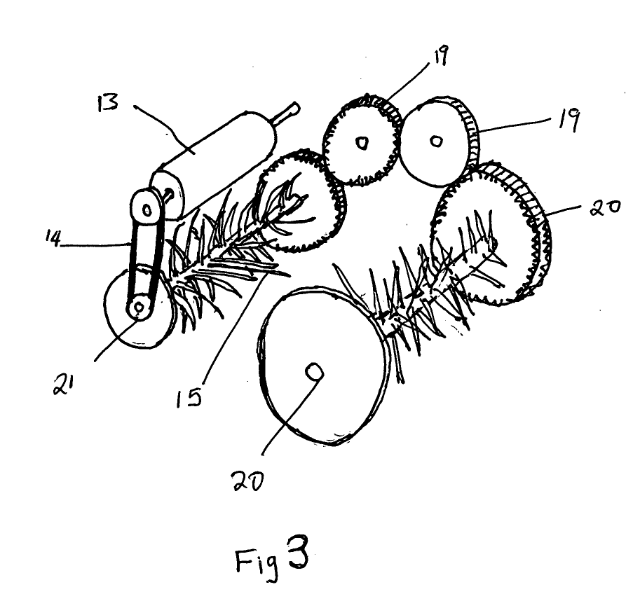

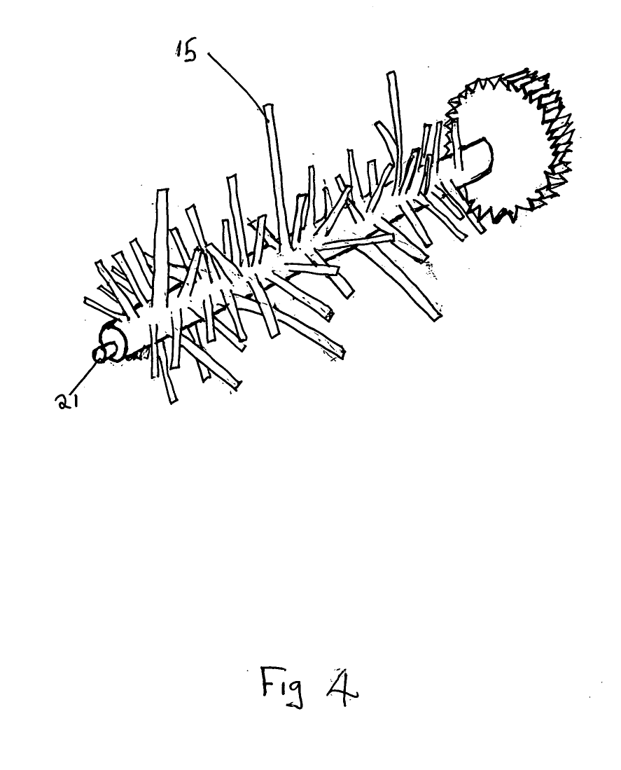

spindle motor 13 is housed in the frame of the base above and away from contact with the brushes or waste. The front spindle is rotated with the aid of belt 14 which is also housed in the frame of the device and connected to the spindle motor 13. The spindle of brush 21 as seen in FIGS. 3 and 4 has a gear at one end which rotates a series of gears. Gear 19 rotates hind brush 20. The gears ensure a complementary rotation of the two brushes so that waste is picked inwards in the direction of the suction.

hand grip 1 has a grooved hand indentation which makes access to the power switch 2 easy with the aid of the thumb when power switch 2 is turned on, the system is activated, both motors are simultaneously turned on, powerful suction is generated by fan 9 and exhaust pot 23 fitted with a disinfectant filter allows air to escape to the surrounding.

the rechargeable pet waste cleaner has been configured as a walking cane with a wheel 18 which makes this device a convenient pet-walking companion.

the front brush 21 is made of several sharp steal blades 15 amongst numerous smaller rubber bristles. Steal blade 15 help to cut waste into smaller bits for easy suctioning.

it is to be understood that the present invention is not limited to the sole embodiment described above, but encompasses any and all embodiments within the scope of the following claims.

### DRAWING REFERENCE NUMERALS

1. Grooved Handle
2. Main Power Switch
3. Flush Switch
4. Inlet for Powering Battery Charger
5. A.C/D.C converter
6. Battery Charger
7. Battery Park
8. Reversible Motor
9. Fan
10. Hinged panel
11. Flush Chamber Opening
12. Flush chamber
13. Spindle Motor
14. Belt
15. Steal Blades
16. Perforation of Flush Chamber
17. Rubber Bristle
18. Single Wheel
19. Gear
20. Back Brush
21. Front Brush.
22. Base Body
23. Exhaust port
24. Hollow waste Chamber
25. Main Body
26. Filter

1. A rechargeable pet waste cleaner incorporating two rotating brushes that picks up waste for easy suctioning by suction created by a reversible motor capable of rotating in two directions.

2. A rechargeable pet waste cleaner incorporating a water and soap flushing chamber.

3. A rechargeable pet waste cleaner incorporating the use of light weight yet strong material and built in a slim manner to also serve as a walking cane with a wheel.

4. A rechargeable pet waste cleaner according to claim 1, wherein the two rotating brushes are made to rotate in opposite directions in a horizontal plain with the aid of gears and a belt

5. A rechargeable pet waste cleaner according to claim 1, wherein the motor rotate in an opposite direction cause the fan to flush the unit.
